(19) United States
(12) Patent Application Publication
(10) Pub. No.: US 2002/0078105 A1
(43) Pub. Date: Jun. 20, 2002

(54) Method and apparatus for editing web document from plurality of web site information

(75) Inventors: Shinichiro Hamada, Kanagawa (JP); Toshibumi Seki, Kanagawa (JP)

Correspondence Address: OBLON SPIVAK MCCLELLAND MAIER & NEUSTADT PC, FOURTH FLOOR, 1755 JEFFERSON DAVIS HIGHWAY, ARLINGTON, VA, 22202, US

(73) Assignee: KABUSHIKI KAISHA TOSHIBA, Tokyo (JP)

(21) Appl. No.: 10/015,604

(22) Filed: Dec. 17, 2001

(30) Foreign Application Priority Data
Dec. 18, 2000 (JP) 2000-383625

(51) Int. Cl. G06F 15/00

(52) U.S. Cl. 707/530

(57) ABSTRACT

In order to edit parts of contents of one or a plurality of first documents described by any markup language on a World Wide Web (WWW) in Internet into a second document described by a specific markup language on the WWW, one or a plurality partial documents are extracted from the first documents according to locations of the first documents on the Internet and ranges of the partial documents to be extracted, described by the specific markup language in the second document, and the extracted partial documents are inserted into the second document according to insertion positions of the partial documents on the second document described by the specific markup language in the second document.

### BACKGROUND OF THE INVENTION

1. Field of the Invention

The present invention relates to a method and an apparatus for composing a single web document from a plurality of web documents.

2. Description of the Related Art

The WWW (World Wide Web) has spread as an information basis by which effective presentations can be constructed and disclosed at low costs, and in which huge information resources are disclosed at various sites worldwide. The WWW also has an aspect as an infrastructure for server-client systems. In particular, there are demands for applications to the electronic commerce and ASP (Application Service Providing) recently, and the fullfledged commerce sites are increasing rapidly. In the electronic commerce, the web page plays a role of an operation panel connecting a user and a back-end system of the enterprise LAN for processing commercial transactions. The WWW is the only infrastructure that connects computer systems worldwide beyond sites, and it is expected that the web top inclined trend will continue in future.

The information resources exchanged by the WWW are steadily increasing, and the processing required at the web system is expected to become more complicated and multifarious.

In particular, the enterprises are very active in utilizing the WWW for disclosing a large amount of data of the own enterprises such as enterprise data, news, product catalog information, etc., but creasing each web page from scratch requires too much human works so that techniques for mechanically creating web pages containing standardized contents either statically or dynamically from databases have been introduced to improve the efficiency of the site construction and operation. Such web site construction and operation tools are provided by many software vendors and they are abundant. However, these techniques are all related to the improvement of efficiency and performance of the construction and operation of a single closed web site.

As the environment for the construction and operation of a single web site is fully developed today, the next demand for the WWW is the coordination among web sites. Namely, there are demands for the development from server-client systems to distributed systems. In particular, in the coming era of the fullfledged electronic commerce, the coordination among electronic commerce systems of various commerce sites will become indispensable.

The coordination of the electronic commerce systems requires many decisions regarding common data format and vocabulary for product profile and the like, a common business model, and common message format and protocol according to the common business model, etc. To this end, there are movements for standardization by the industrial communities such as OASIS and BizTalk, but there are many barriers such as conflicting interests among enterprises and differences in the custom of trade so that a considerable amount of time is expected to be necessary for obtaining the fruitful results.

On the other hand, various software vendors are now providing packages with a mechanism for coordinating web sites added to the above described web site construction and operation tools in order to meet the increasing demands.

However, the conventional system construction method based on the application logic group centered around databases can only function effectively by regarding a web page for a single web site as a simple user interface, and cannot be applied directly to a system formed over a plurality of web sites. This is because this construction method requires a connection of application logics in order to realize the system coordination, but there is a firewall that separates between sites so that the exchange of messages other than those of HTTP is impossible in most cases.

Consequently, there is a need for a system unification model based on HTTP which is the only available message exchange channel, but many packages only add the HTTP access function to the conventional site construction technique so that the functions of HTTP and WWW have not been fully exploited.

As such, the system coordination among sites is an essentially difficult subject that requires many decisions in order to connect logics of various systems.

For this reason, when the attention is paid to the coordination among web sites using contents exchange rather than the logic connection, it can be seen that the contents coordination among web sites has fewer problems to be resolved compared with the system coordination among web sites because it only requires an adjustment such as a structure conversion of web resources.

However, on the other hand, the effect realizable by the contents coordination can be sufficiently large. As mentioned above, the huge amount of web resources are already disclosed in the WWW. In addition, the web resources use multimedia that can cover any kind of contents media. If there is an environment in which such web resources can be re-utilized easily among sites upon mutual agreement, the WWW can be made far more rational and economical, so that the significant advances in the application of the WWW can be envisaged.

For example, it becomes possible to realize a distributed management type web site construction style using the out-sourcing of a part of information resources constituting the web site such as book sales information or TV program rating information, and there is even a possibility for creating a large web parts market.

Also, many portal sites for providing the agent service such as a shopping mall for comparatively displaying product catalogs of various shopping sites on a single web page and a market place for unifying items of a plurality of supply systems or auction systems have appeared recently and attracting much attentions. This is because of the inevitably increasing demands for a service that classifies the web information or a service that plays a role of the guide under the circumstance facing with the flooding of the web information, and the portal site provides one way of meeting these demands.

The realization of an environment for enabling mutual re-utilization of web resources can contribute significantly to the construction of such portal sites. From this point of view, it can be regarded as a steady technical transition that can lead to the system coordination among the web sites such as electronic commerce systems.

As such, many portal sites for providing the agent service that unifies a plurality of web site information such as a web page search service or various product comparison service have appeared recently and attracting much attentions, and such an agent service has been further developing into directions of specialization and diversification of functions such as image gathering and MP3 gathering. The essence of these task is the contents coordination among web sites which gather the distributed web resources and provides their processed results as web pages.

In the HTML technique, it is possible to enable a jump to arbitrary web page by using a hyperlink mechanism or realize a display of a plurality of web pages as a while as an independent window by using a frame mechanism, but it is quite insufficient to realize the organic contents coordination such as that for providing the product comparison function or a total charge estimation function. In order to realize these functions, there is a need for a function to gather arbitrary web pages and process them flexibly. Such a function is lacking in the HTML so that a normally adopted method is to carry out such a processing by using an external program executed by a program activation mechanism such as CGI (Common Gateway Interface) or Servlet or a daemon program independent from the web server.

This processing generally requires the following execution procedure.

1. A processing for acquiring an HTML page from the external web site;

2. A processing for extracting necessary texts from the HTML page;

3. A processing for converting the extracted texts into a desired format; and

4. A processing for creating a single HTML document by composing texts.

In addition, in the case of using databases, the processing for registration or extraction of data with respect to the databases will be added.

This solution has the drawback in that the production efficiency and the maintenance capability are poor because each site constructor produces programs from scratch, despite of the fact that these processings have similar contents among many agent services. Also, the produced programs are dependent on the environment of that site so that they are inevitably program resources specific to that site and cannot be re-utilized under other site environments.

These drawbacks are caused by the fact that there is no tool or system for specifically targeting and readily realizing the contents coordination in the WWW technology.

As described, conventionally, there has been a problem that there is no generic method for gathering necessary information from a plurality of web pages, carrying out the processing for converting them into a specific format, etc., and then composing them on a single web page.

Providing a common platform specialized for the contents coordination can be an effective way in terms of the production efficiency and the portability, under the future circumstance in which the agent services such as portal sites for gathering a plurality of web site information are expected to be more active.

### BRIEF SUMMARY OF THE INVENTION

It is therefore an object of the present invention to provide a method and an apparatus which are capable of composing a plurality of web site information into a single web document easily and generically.

According to one aspect of the present invention there is provided a document editing method for editing parts of contents of one or a plurality of first documents described by any markup language on a World Wide Web (WWW) in Internet into a second document described by a specific markup language on the WWW, comprising: extracting one or a plurality partial documents from the first documents according to locations of the first documents on the Internet and ranges of the partial documents to be extracted described by the specific markup language in the second document; and inserting the partial documents extracted by the extracting step into the second document according to insertion positions of the partial documents on the second document described by the specific markup language in the second document.

According to another aspect of the present invention there is provided a document editing apparatus for editing parts of contents of one or a plurality of first documents described by any markup language on a World Wide Web (WWW) in Internet into a second document described by a specific markup language on the WWW, comprising: an extraction unit configured to extract one or a plurality partial documents from the first documents according to locations of the first documents on the Internet and ranges of the partial documents to be extracted described by the specific markup language in the second document; and an insertion unit configured to insert the partial documents extracted by the extraction unit into the second document according to insertion positions of the partial documents on the second document described by the specific markup language in the second document.

According to another aspect of the present invention there is provided a computer program product for causing a computer to function as a document editing apparatus for editing parts of contents of one or a plurality of first documents described by any markup language on a World Wide Web (WWW) in Internet into a second document described by a specific markup language on the WWW, the computer program product comprising: first computer program codes for causing the computer to configured to extract one or a plurality partial documents from the first documents according to locations of the first documents on the Internet and ranges of the partial documents to be extracted described by the specific markup language in the second document; and second computer program codes for causing the computer to an insertion unit configured to insert the partial documents extracted by the first computer program codes into the second document according to insertion positions of the partial documents on the second document described by the specific markup language in the second document.

Other features and advantages of the present invention will become apparent from the following description taken in conjunction with the accompanying drawings.

### BRIEF DESCRIPTION OF THE DRAWINGS

FIG. 1 is a block diagram showing a network system with a web server (XML-P'z server) incorporating an XML-P'z language processing system according to one embodiment of the present invention, for explaining its basic operation.

FIG. 2 is a block diagram showing an exemplary overall configuration of an XML-P'z language processing system according to one embodiment of the present invention.

FIG. 3 is a flow chart showing a processing operation of an HTML judging unit of an XML normalizer in the XML-P'z language processing system of FIG. 2.

FIG. 4 is a flow chart showing a processing operation of an HTML-XML converter of an XML normalizer in the XMLP'z language processing system of FIG. 2.

FIG. 5 is a flow chart showing a processing operation of an XPointer processor of an XML normalizer in the XMLP'z language processing system of FIG. 2.

FIG. 6 is a flow chart showing a processing operation of an interpretation buffer initializer of an XML normalizer in the XML-P'z language processing system of FIG. 2.

FIG. 7 is a flow chart showing a processing operation of a context manager of an interpreter in the XML-P'z language processing system of FIG. 2.

FIG. 8 is a flow chart showing a processing operation of a targets command processor of an interpreter in the XML-P'z language processing system of FIG. 2.

FIG. 9 is a flow chart showing a processing operation of a convert command processor of an interpreter in the XML-P'z language processing system of FIG. 2.

FIG. 10 is a flow chart showing a processing procedure for an interpreting side judgement processing in the network system of FIG. 1.

FIGS. 11A and 11B are diagrams showing document structures of an exemplary XML-P'z document handled by the XML-P'z language processing system of FIG. 2 before and after interpretation processing.

FIG. 12 is a diagram showing an exemplary document structure of an XML-P'z document handled by the XML-P'z language processing system of FIG. 2 for explaining an interpretation order.

FIG. 13 is a flow chart showing a series of operations for combining a plurality of web documents on a single web document in the XML-P'z language processing system of FIG. 2.

FIG. 14 is a flow chart showing a partial document insertion processing used in the series of operations shown in FIG. 13.

FIG. 15 is a flow chart showing a conversion processing used in the series of operations shown in FIG. 13.

FIG. 16 is a diagram showing a part of an exemplary XML-P'z document that can be used as a composition web document in the XML-P'z language processing system of FIG. 2.

FIG. 17 is a diagram showing an outline of an XML-DOM tree corresponding to the exemplary XML-P'z document of FIG. 16.

FIG. 18 is a diagram showing an outline of an XML-DOM tree corresponding to the exemplary XML-P'z document of FIG. 16 after interpreting a pz:targets element.

FIG. 19 is a diagram showing an exemplary XSLT document described in the exemplary XML-P'z document of FIG. 16.

FIG. 20 is a diagram showing an outline of an XML-DOM tree corresponding to the exemplary XML-P'z document of FIG. 16 after interpreting a pz:targets element and a pz:convert element.

### DETAILED DESCRIPTION OF THE INVENTION

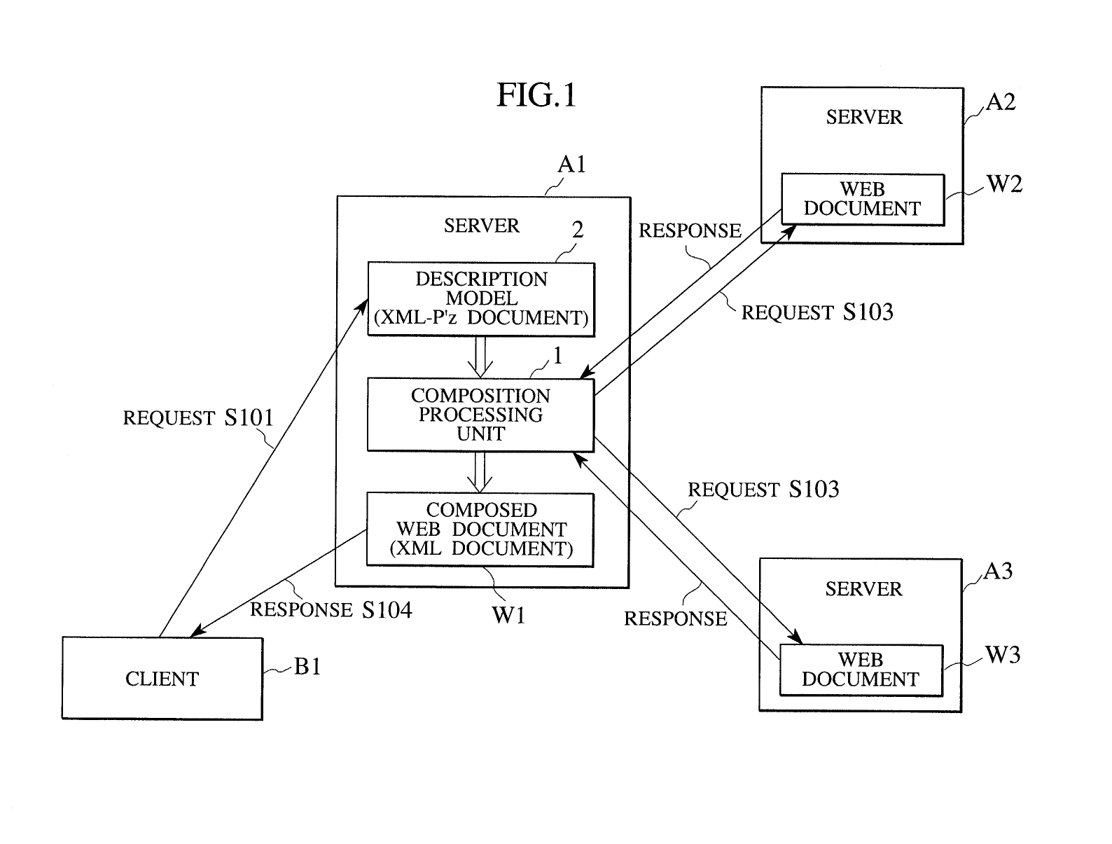

Referring now to FIG. 1 to FIG. 20, one embodiment of a method and an apparatus for composing a single web document from a plurality of web documents will be described in detail.

(A) Functions Required for Composing a Plurality of Web Site Information into a Single Web Document:

First, before describing this embodiment, functions required for composing a plurality of web site information (web documents) into a single web document will be described.

The functions required for composing a plurality of web documents into a single web document can be narrowed down to three types including extraction, insertion and conversion. However, in general, not necessarily the entire web document (HTML document, for example) but only a part of it will be required as the web site information, i.e., contents, so that the extraction function is required to extract a partial document from arbitrary web document. Also, the insertion function is required to be flexible such that a table can be inserted into a table at a time of composition by combining a plurality of extracted partial documents. In addition, there can be cases where it is insufficient to have just these functions and a document conversion function is required in order to adjust the extracted partial documents into the same format when they have non-uniform formats at a time of composing them into a form of a list.

Based on this analysis, the present invention adopts the following description model. First, the present invention adopts a patchwork-like document processing scheme in which commands are to be arranged at arbitrary positions within a composition web document for composing a plurality of web documents (partial documents) and then the execution results of these commands are to be embedded at the corresponding positions, similarly as SSI (Server Side Inclusion) and its descendant such as ASP (Active Server Pages) or JSP (Java Server Pages).

Then, the commands to be provided include a partial document insertion command indicating which portion of which web page is to be extracted and where it is to be inserted. This method has an advantage in that the specification of the partial document to be extracted and its insertion position can be described freely and intuitively by using the composition web document that provides a framework. In addition, there is also provided a conversion command capable of applying a conversion processing with respect to arbitrary range in the composition web document that provides a framework. This conversion command receives a range information and a conversion rule as inputs and outputs a document obtained as a conversion result.

In other words, the description scheme capable of embedding composition logics at arbitrary positions in the composition web document is adopted, and the insertion command and the conversion command are provided as the composition logic commands.

Also, one of the adopted execution models is similar to SSI, in which the composition web document is provided at the web server, and when there is a request to that URL from the browser, a language processing system provided at that web server interprets and executes commands contained in that composition web document and returns execution results to the browser. In this method, there is an advantage in that the site constructor only needs to provide the composition web document at the web server and does not have to be conscious of the activation of the interpretation and the execution. However, besides such an execution method, it is in principle also possible for a user to activate the interpretation and the execution manually.

Now, the optimal language for the description of such a composition web document is XML (extensible Markup Language). In the XML, tag names and attribute names can be defined freely and semantics for them can be given by the application side. In addition, the XML is guaranteed to have a tree type document structure, so that a partial document (a document range) can be specified by pointing a specific element expressed as a node on the document structure expressed by the tree structure.

Also, the XML has the well developed conversion system techniques such as XSLT (eXtensible Stylesheet Language Transformations) (see http://www.w3.org/TR/xslt) because the XML itself is demanded as a standard data format at low level, and even in the future development of the XML technology, the extensibility and the convenient features such as tool utilizability can be promised by describing the above described composition web document by a language based on this XML language (an applied XML language according to the present invention).

There is also an advantage in that the XML is convenient for handling as the extraction targets when more XML documents are used in addition to HTML documents in future.

For these reasons, in the present invention, the description language for the composition web document is specifically designed as the applied XML language.

In the present invention, the composition web document (which will also be referred to as a composition web page) to be a basis of the composition is described by the XML, a portion (partial document) of a range specified from the other specified web document is extracted and inserted into a specified position in the composition web document, and a conversion processing (a processing for conversion into a desired document structure) is applied to a specified range of the composition web document. Thus the present invention adopts a policy of providing two composition logic commands including insertion and conversion as elements in the composition web document.

Such a composition web document which is an XML document (XML page) will be referred to as an XML-P'z (XML-Pieces) document (XML-P'z page) here.

By incorporating the XML-P'z language processing system in the web server, the operation as shown in FIG. 1 becomes possible. Note that the web server in which the XML-P'z language processing system will also be referred to as an XML-P'z server. In the following, a specific example of incorporating the XML-P'z language processing system into IIS (Internet Information Server), which is a web server of the Microsoft corporation, will be described.

In the basic operation principle shown in FIG. 1, at the step S101, a request (GET/HTTP) for an XML-P'z document 2 is transmitted from a web browser of a client terminal B1 to an XML-P'z server A1 (which will be referred to simply as a server A1 hereafter).

At the step S102, the server A1 judges whether the requested resource is the XML-P'z document or not.

At the step S103, when it is judged as the XML-P'z document, the server A1 activates the XML-P'z language processing system (a composition processing unit 1 of FIG. 1), extracts portions (partial documents) of specified ranges from web documents (pages) W2 and W3 of specified web servers (web servers A2 and A3 in this example). inserts them into specified positions in the XML-P'z document, and applies a conversion processing to a specified range described in the XML-P'z document. Eventually, an XML document (a composed web document) W1 is obtained as a processing result of the XML-P'z language processing system.

At the step S104, the obtained XML document is transmitted to the browser as a response to the request source.

The above described operation is realized by the setting of the web server. Most web servers have a function for setting a correspondence between a URL character string pattern (which is often an extension of an object) and add-in necessary for preliminary processing that, and the steps S102 and S103 can be realized by utilizing this function.

It is also possible to use a processing which returns the XML document when the web browser can display the XML document or returns the HTML document by carrying out the stylesheet processing at the server A1 side when the web browser cannot display the XML document.

(B) XML-P'z Document:

In the XML-P'z document, an insertion command element “pz:targets” and a conversion command element “pz:convert” are defined.

As a child document under one element in the document structure expressed by the tree structure of the XML-P'z document, a partial document of another XML document or HTML document can be inserted (composed) by using an insertion command tag. In order to specify an insertion target partial document, a URL with XPointer (see http://www.w3.org/TR/WD-xptr#uri-escaping) is adopted. Using this, the partial document of a specific web page can be specified compactly by a single line. Note however that the XPointer specification is intended for the XML so that the HTML cannot be set as a target directly. For this reason, a mechanism for carrying out the structurally equivalent HTML-XML conversion by using HTML-DOM (Document Object Model) and XML-DOM at a time of extraction is introduced. Using this, the HTML document can be handled as the XML document so that all the processings can be carried out with respect to the XML.

Also, in the XML-P'z document, a conversion operation using the XSLT with respect to each child document under arbitrary element (node) can be executed by using a conversion command element. Namely, the specified XSLT is applied to each child document to be arranged as a child node of the conversion command element as specified by the conversion command element. Utilizing this, the web document inserted by the insertion command tag can be converted by using the conversion command tag.

In the following, one simple example of the XML-P'z document having the insertion function and the conversion function using the insertion command element and the conversion command element will be described.

(First example of the XML-P'z document)

1. <?xml version=“1.0”?>

2. <root xmlns:pz=“http://www.shiba.co.jp/xmlpz”>

3. <category>xxx</category>

4. <item_holder>

5. <pz:convert href=“xxx.xsl”>

6. <pz:targets href=“http://www.yyy.com/index.xml#xpointer(//item)”/>

7. </pz:convert>

8. </item_holder>

9. </root>

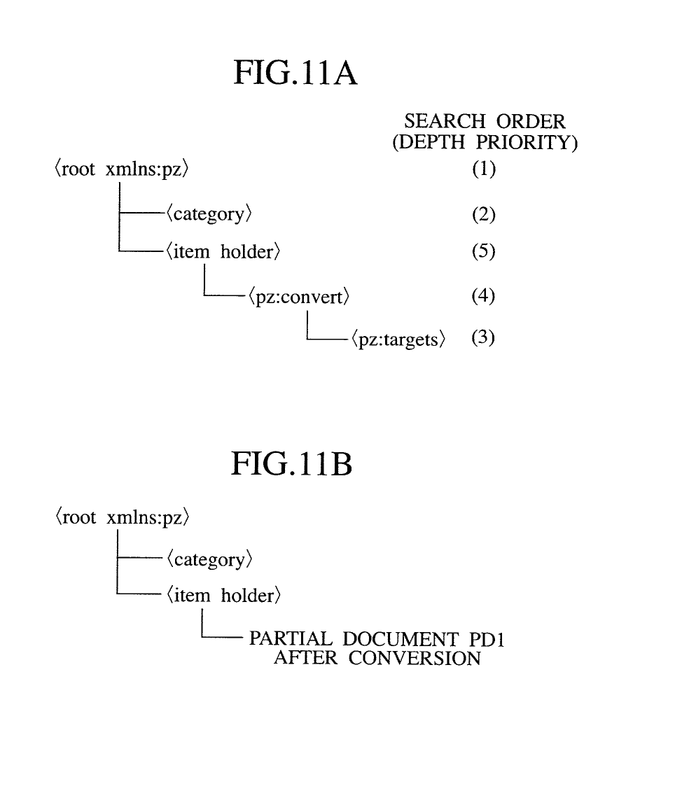

FIG. 11A schematically shows the document structure of the first example described above, and FIG. 11B schematically shows the document structure of the XML document after the interpretation of the first example described above.

In the first example described above, each XML partial document (“http://www.yyy.com/index.xml#xpointer(//item)” which will be referred to hereafter simply as a partial document PD1), which is the insertion target specified by the insertion command element “pz:targets” on line 6, is converted by having the conversion rule of the XSLT as specified by the conversion command element “pz:convert” on line 5, and inserted as a child element of the element “item-holder” appearing on lines 4-8, as shown in FIG. 11B. Note however, that the web documents specified by “pz:targets” on line 6 are all partial documents that match with the XPointer (all the partial documents which have “item” tag as a root in the case of the first example described above), which include a plurality of web documents in general.

The web document composition method for the distributed web resources as described above has the following advantages.

One of the advantages is that the construction is easy. Unlike the conventional method centered around databases, this method can describe the information resource composition logics compactly without using the programming language, so that the construction and change of the configuration for the web document integration are easy. Also, the interpreter type execution model for which the interpretation processing is carried out at a time of the request from the browser is adopted so that the change of the composition logics will be reflected immediately.

Another advantage is its high re-utilizability. In the framework of the XML-P'z, all the constituent elements including contents, conversion rules, and composition logics are provided as web resources. Unlike the conventional method in which the composition logics are provided as programs outside the web documents, this method can access all these constituent elements through the URL, so that they can be re-utilized from web systems around the world in principle. This implies that each resource necessary for the distributed system beyond the web site is arranged freely, so that it becomes possible to realize flexible system construction and change according to the system operation.

In addition, the composition logics can be divided (coordinated) among web sites when one XML-P'z document at one site has another XML-P'z document at another site as the composition target.

Also, no special protocol other than HTTP is used, so that there is no need for the web site that provides the web resources to introduce any special processing system. Consequently, any web site information resources can be set as the re-utilization target. In other words, the existing web site can utilize the system resources without any change, and it is possible to realize the composition by separately creating the XML-P'z resources.

However, such a high accessibility may give rise to a problem on the practical operation regarding the utilization such as the copyright problem. For example, when the XML-P'z technique is utilized, it is easily possible to provide a meta-search page for composing the search results of a plurality of web sites that are providing the web search services, but this can give rise to the copyright problem. Such a problem also arises in relation to the permission for hyperlink even in the current WWW, which is presently being handled by the system operation. In this regard, the WWW techniques related to the access control such as the Extranet construction technique have already been provided, while the legislation regarding the handling of writings disclosed on the WWW is currently in progress rapidly. Even in the XML-P'z framework, an introduction of a model for comprehensively handling the copyright program remains as a future problem to be resolved.

Next, the web document composition method for the distributed web resources as described above will be described in further detail.

The XML-P'z language is a web page description language containing the composition logics, which is a core of this system. In the following, XML-P'z language specification will be described in sub-section (B-1), and then the configuration and operation of XML-P'z language processing system as a language engine for carrying out the interpretation processing on the XML-P'z document described by the XML-P'z language and returning the processing result will be described in sub-section (B-2).

(B-1) XML-P'z Language Specification:

The XML-P'z language is one of the applied XML languages in which semantics are given with respect to specific tag names, which is the web document description language aimed at the composition of the distributed web resources. Similarly as the usual XML document, it is possible to describe contents, and in addition it is possible to include the composition logics with respect to arbitrary elements within the web document by describing the tag names for commands to operate the web resources. This description of the composition logics is as compact as hyperlinks of the HTML.

Such an XML-P'z document containing the composition logics described by the XML-P'z language is interpreted into a web document in which the distributed resources are virtually integrated or composed according to the composition logics.

There are two command elements regarding the web resource operations, including “targets” and “convert”, and an XML namespace “pz” is reserved. By combining these command elements, it is possible to carry out the extraction of arbitrary partial document including the other web document, the insertion of the own document, and the structure conversion using the XSLT. In the following each command element (pz:convert element, pz:targets element) will be described in detail.

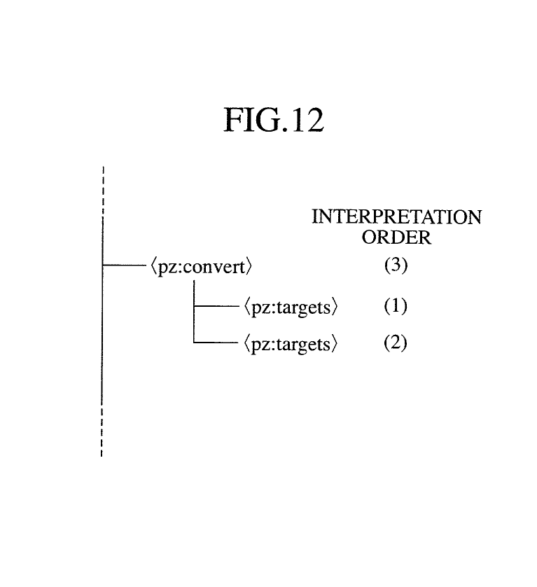

Also, these command elements must be interpreted in the search order based on the depth priority. For example, in the document structure of the XML-P'z document shown in FIG. 12, when there are a plurality of pz:targets elements as child elements of the pz:convert element, these pz:targets elements are interpreted sequentially from an older brother to a younger brother, and then the pz:convert element is interpreted.

Also, as explained in relation to the command tags, the web document to be inserted by the insertion command element and the web document to be converted by the conversion command element must be interpreted as the XML-P'z documents before the composition or the conversion. Namely, when the command elements (insertion command element, conversion command element) are contained within the web document to be inserted or converted by the command element, these contained command elements are interpreted at higher priority in the above described order, and then the execution of the interpretation of this insertion target XML-P'z document is continued, according to the recursive interpretation processing flow.

Also, the URL with XPointer for specifying the web resource is introduced. This is basically according to the XPointer specification (see http://www.w3.org/TR/WD-xptr), but the relative specification by the URL with XPointer is undefined in that specification, so that this is originally defined in the XML-P'z language. This specification is as follows.

(XML Namespace)

In order to utilize each command tag of the XML-P'z, the following namespace must be declared.

* Namespace name:

pz

* Namespace URI:

http://shiba.co.jp/xmlpz

(pz: ;targets element)

An element for extracting and inserting arbitrary web resources.

* Grammar:

<pz:targets href=“web-resources-url”>

</pz:targets>

* Attribute:

href

The URLs for a plurality of web resources that are the insertion targets. When the URL is the URL with XPointer, all partial documents that match with the XPointer pattern in the web document of a body portion of the URL will be specified.

* Structural limitation:

Parent element: arbitrary

Child element: none

* Comment:

The pz:targets element interprets a single or a plurality of web resources specified by the href attribute as the XML-P'z documents and inserts them into the context of the pz:targets element, and then the pz:targets element itself disappears. When the URL indicated by the href attribute is the URL with XPointer, all partial documents that match with the XPointer pattern in the web document of a body portion of the URL will be specified.

* Sample:

The following example shows an XML-P'z document that takes in all book data contained in “http://www.xxx.com/booklist.xml” page in addition to the book data contained in the own document.

1. <?xml version=“1.0”?>

2. <bookstore specialty=“novel”>

3. xmlns:pz=“http://www.shiba.co.jp/xmlpz”>

4. <book style=“textbook”>

5. <author>

6. <first-name>Shinichiro</first-name>

7. <last-name>Hamada</last-name>

8. <publication>Selected Short Stories of

9. <first-name>Shinichiro</first-name>

10. <last-name>Hamada</last-name>

11. </publication>

12. </author>

13. <price>55</price>

14.</book>

15.<pz:targets href=“http://www.xxx.com/booklist.xml#xpointer(//book)”/>

16.</bookstore>

(pz:convert element)

An element for converting arbitrary partial documents by using the XSLT documents.

* Grammar:

<pz:convert href=“xslt-url”>

</pz:convert>

* Attribute:

href

The URLs for the XSLT documents defining the conversion rules. When the URL is the URL with XPointer, a top partial document in an order of documents among all partial documents that match with the XPointer pattern in the web document of a body portion of the URL will be specified.

* Structural limitation:

Parent element: arbitrary

Child element: arbitrary

* Comment:

The pz:convert element converts each child document under this element by applying the XSLT documents specified by the href attribute. Each converted child document is interpreted as the XML-P'z document and inserted into the context of the pz:convert element, and then the pz:convert element itself disappears. When the URL indicated by the href attribute is the URL with XPointer, a top partial document in an order of documents among all partial documents that match with the XPointer pattern in the web document of a body portion of the URL will be specified.

* Sample:

The following example shows an XML-P'z document that converts all textbook data contained in “http://www.xxx.com/booklist.xml” page into a common book format according to the conversion rule described in the XSLT document “textbook-book.xsl”, and takes in all the converted book data in the common book format obtained from the book data disclosed in “http://www.yyy.com/index.html” page in addition to the textbook data contained in the own document which are expressed by the “textbook” elements.

1. <?xml version=“1.0”?>

2. <bookstore specialty=“novel”>xmlns:pz=“http://www.shiba.co.jp/xmlpz”>

3. <pz:convert href=“textbook-book.xsl”>

4. <textbook>

5. <author>

6. <first-name>Shinichiro</first-name>

7. <last-name>Hamada</last-name>

8. <publication>Selected Short Stories of

9. <first-name>Shinichiro</first-name>

10. <last-name>Hamada</last-name>

11. </publication>

12. </author>

13. <price>55</price>

14. </textbook>

15. <pz:targets href=“http://www.xxx.com/booklist.xml#xpointer(//textbook)”/>

16. </pz:convert>

17. <pz:convert href=“html-book.xsl”>

18. <pz:targets href=“http://www.yyy.com/index.html#xpointer(//TABLE[2]//TR)”/>

19. </pz:convert>

20.</bookstore>

(Relative Specification of the URL with XPointer)

When the web resource specifies another web resource to be referred, a relative URL based on the URL having the own web resource can be used. This is referred to as a relative URL. In order to uniquely identify the resource, there is a need for the processing system to resolve the relative URL into the absolute URL. The method for this resolution is shown in the following. Note however that, in the following description, it is assumed that the terminology is based on the IETF (see http://www.ietf.org/rfc/rfc1738.txt).

(1) Case where the Base URL Object and the Relative URL Object are Different:

The XPointer fragment (if any) of the relative URL is attached to a result obtained by the resolution of the relative URL according to the IETF (see http://www.ietf.org/rfc/rfc1808.txt) between a body portion in which the XPointer fragment (if any) is removed from the base URL and a body portion in which the XPointer fragment (if any) is removed from the relative URL. Note that the XPointer fragment is a portion following “#xpointer” in the description of the sample below, such as “xpointer(/node1/node2)” and “#xpointer(./node3//node4), for example.

* Sample:

(Base URL) http://aaa.com/dirl/xxx.xml#xpointer(/node1/node2)

(Relative URL) ./dir2/yyy.xml#xpointer(./node3//node4)

(Resolution result) http://aaa.com/dir1/dir2/yyy.xml#xpointer (./node3//node4)

(2) Case where the Base URL Object and the Relative URL Object are the Same:

A node indicated by the XPointer (if any) of the relative URL is determined and the XPointer fragment indicating that node path is attached to the URL of this object, using a document node indicated by the XPointer if the base URL contains the XPointer fragment as a starting point, or using a root document node as a starting point if the base URL does not contain the XPointer fragment.

* Sample:

(Base URL) http://aaa.com/dirl/xxx.xml#xpointer(/node1/node2)

(Relative URL) http://aaa.com/dirl/xxx.xml#xpointer(./node3//node4)

(Resolution result) http://aaa.com/dirl/xxx.xml#xpointer (/node1/node2/node3//node4)

(3) Case where the Object is not Specified in the Relative URL:

A node indicated by the XPointer (if any) of the relative URL is determined and the XPointer fragment indicating that node path is attached to the URL of the object of the base URL, using a document node indicated by the XPointer if the base URL contains the XPointer fragment as a starting point, or using a root document node as a starting point if the base URL does not contain the XPointer fragment.

* Sample:

(Base URL) http://aaa.com/dirl/xxx.xml#xpointer(/node1/node2)

(Relative URL) #xpointer(./node3//node4)

(Resolution result) http://aaa.com/dirl/xxx.xml#xpointer (/node1/node2/node3//node4)

(B-2) Configuration and Operation of the XML-P'z Language Processing System:

Next, the interpretation processing system for the XML-P'z language will be described.

The XML-P'z language processing system is a software component using the URL or source indicating a location of the XML-P'z document as input and its interpretation result in a form of the XML document source as output. This processing system adopts a scheme for carrying out the interpretation processing of the XML-P'z language in two paths, where the XML-DOM tree is created by carrying out the syntax analysis as the XML document in the first path, and then the interpretation processing of the command elements (portions enclosed by insertion or conversion command tags) specific to the XML-P'z language while tracing the XML-DOM tree according to the depth priority in the second path.

In this language processing, the processing policy for outputting the best possible result is adopted by continuing the interpretation processing even when the grammatical error is discovered or when a run time error due to a network trouble or the like occurs.

Also, in the XML-P'z language, the web resource specification using the URL with XPointer is possible, and this processing system adopts a scheme for carrying out the two stage processing in which the entire document indicated by the URL is downloaded and then the partial document specified by the XPointer is extracted. In this way, it is possible to request the web resources even with respect to most web servers which are not capable of handling the URL with XPointer.

The above is the basic processing policy, and now the exemplary system configuration of this processing system based on this processing policy will be described.

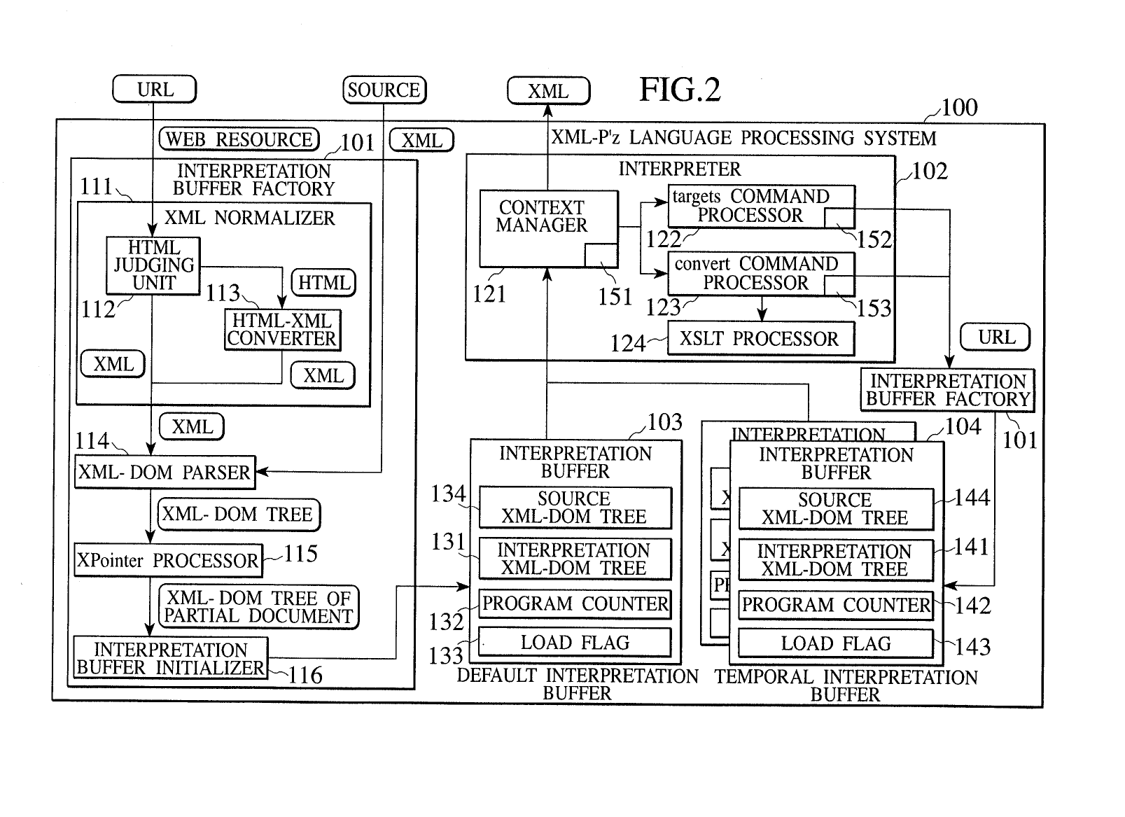

FIG. 2 is an exemplary overall configuration of the XML-P'z language processing system 100 (corresponding to the composition processing unit 1 of FIG. 1). In FIG. 2, this language processing system 100 generally comprises an interpretation buffer factory 101 which is a processing module related to the reading of the XML-P'z documents, and an interpreter 102 which is a processing module for returning the XML document obtained as a result of interpreting the read documents. These two modules basically operate independently. Note that two interpretation buffer factories 101 shown in FIG. 1 are actually the identical element which is drawn in two only for the purpose of clarity.

The interpretation buffer factory 101 starts its operation by an input of the URL or source indicating the location of the XML-P'z document as a trigger. First, at an XML normalizer 111, if the input document is an XML document, the input document is directly sent to an XML-DOM parser 114, or if the input document is an HTML document, the equivalent conversion processing into an XML document having the equivalent structure is carried out and the result is sent to the XML-DOM parser 114. Then, the XML-DOM tree is created at the XML-DOM parser 114, the partial documents are extracted according to the XPointer fragments contained in the URL at the XPointer processor 115, and interpretation buffers 103 and 104 are generated at an interpretation buffer initializer 116.

In addition, when the input of the URL or source is from the external of the processing system 100, the generated interpretation buffer is registered as a default interpretation buffer 103. Here, the interpretation buffer is a state memory of the XML-P'z language interpretation processing which is frequently updated during the interpretation processing by the interpreter 102.

On the other hand, the interpreter 102 starts its operation when there is a request for the interpretation result from the external of the processing system 100. The interpretation of two command elements including the pz:targets element and the pz:convert element is carried out while tracing the interpretation XML-DOM tree 131 according to the depth priority, and the XML document eventually obtained as the interpretation result is outputted.

Here, in order to carry out the XML-P'z interpretation processing for the partial document that is temporarily generated during the interpretation of the command element, a temporal interpretation buffer 104 is generated by using the interpretation buffer factory 101.

Next, the processing operation of each module constituting the interpretation buffer factory 101 will be described.

The XML normalizer 111 constituting the interpretation buffer factory 101 comprises an HTML judging unit 112 and an HTML-XML converter 113.

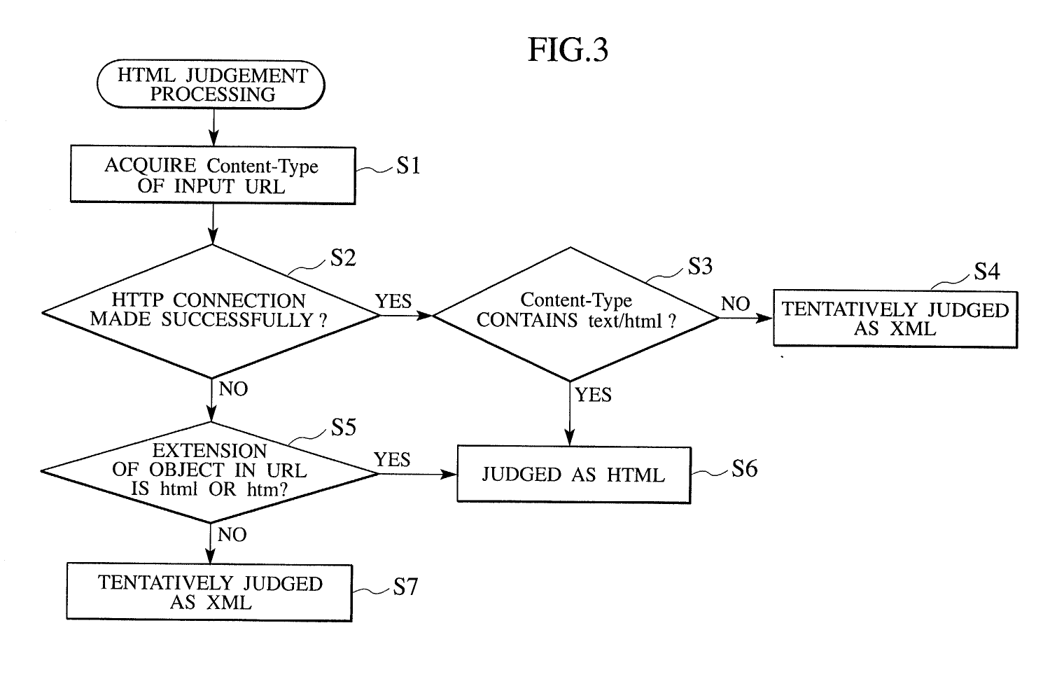

The HTML judging unit 112 judges whether the web resource (web document) indicated by the entered URL is an HTML document or an XML document. For this judgement, the two stage test with a method using “Content-Type” of the HTTP header and a method using an extension contained in the URL is carried out. This processing operation is shown in FIG. 3.

In FIG. 3, first, the “Content-Type” is acquired (step S1). As a method for this acquisition, a method for making a HEAD request with respect to that URL is the most direct one. However, there are many web servers which cannot understand the HEAD request in this world. It is also possible to use a GET request instead. Next, whether the HTTP connection with respect to this URL is made successfully or not is judged (step S2). If the connection is made successfully, the processing proceeds to the step S3, whereas otherwise the processing proceeds to the step S5.

At the step S3, the “Content-Type” header is taken out and whether a character string “text/html” is contained in there or not is judged. If it is contained, this document is judged as an HTML document and the processing is terminated (step S6), whereas otherwise this document is tentatively judged as an XML document and the processing is terminated (step S4).

At the step S5, whether the extension of the object field in the URL is either “html” or “htm” or not is judged. If it is, this document is judged as an HTML document and the processing is terminated (step S6), whereas otherwise this document is tentatively judged as an XML document and the processing is terminated (step S7).

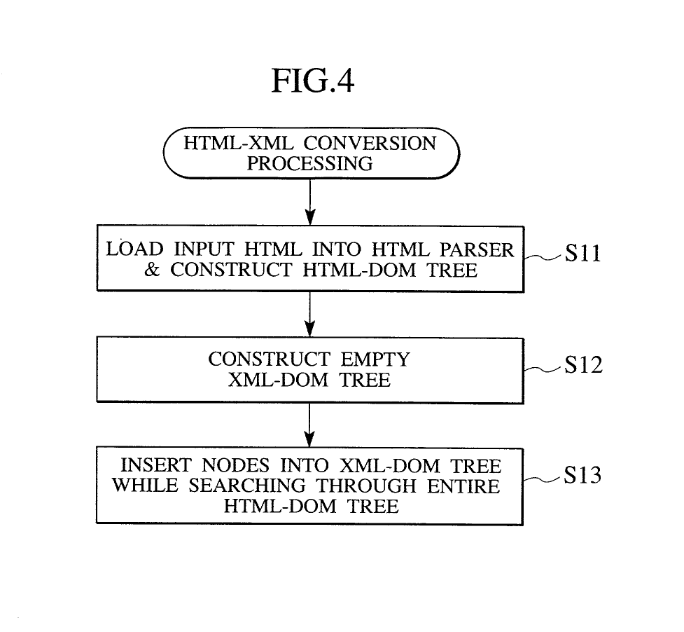

The HTML-XML converter 113 converts the web resource that is judged as the HTML document by the HTML judging unit 112 into the structurally equivalent XML document. This can be realized by sequential shifting from the HTML-DOM tree to the XML-DOM tree by using the method of each DOM. The processing operation of the HTML-XML converter 113 is shown in FIG. 4.

First, at the step S11, the entered HTML document is read into an HTML parser and the HTML-DOM tree is constructed. The HTML parser is preferably one that is internally used by the web browser, because the HTML parser used by the web browser has an error recovery function with respect to the HTML grammatical errors.

Next, at the step S12, an empty XML-DOM tree is constructed by using an XML-DOM parser. Then, at the step S13, while carrying out the search through the entire HTML-DOM tree, values of encountered nodes are taken out and inserted as nodes into the XML-DOM tree.

By the above described processing, at the XML normalizer 111, the web resources entered into the interpretation buffer factory 101 as URLs are all outputted in forms of the XML documents. On the other hand, the web resources entered as sources are handled by assuming that they are all XML documents.

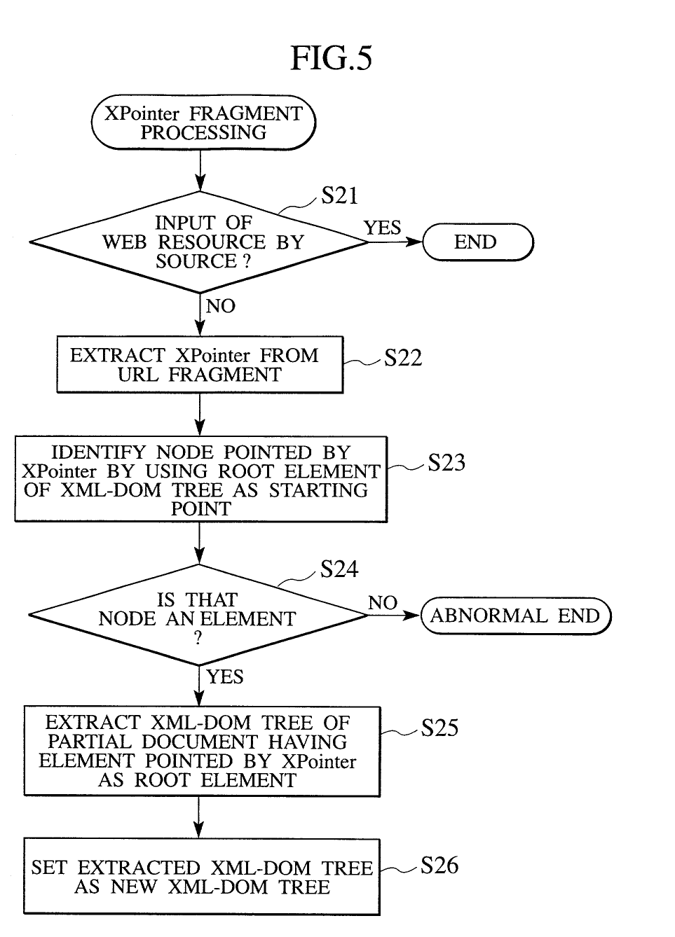

The XML document that passed the XML normalizer 111 or the XML document that is entered as a source is sent to the XML-DOM parser 114 where the XML-DOM tree is formed. In addition, the XML-DOM tree of the partial documents in the XML document indicated by the XPointer fragments in the URL is obtained by using the XPointer processor 115. The processing operation of the XPointer processor 115 with respect to the XPointer fragments is shown in FIG. 5.

First, at the step S21, whether the entered web resource is the web resource entered by the URL or the web resource entered by the source is judged. If it is the web resource entered by the source, there is no URL so that the processing is terminated at this point.

Next, at the step S22, the XPointer fragment is extracted from the URL fragment. Here, if no XPointer is specified, an empty character string is set to the XPointer fragment. Then, at the step S23, a node pointed by the XPointer is identified by using a root element of the XML-DOM tree as a starting point. For this operation, the general XPointer processing system can be used.

Next, at the step S24, the pointed node is an element or not is judged. If it is not an element, the processing is abnormally terminated. Then, at the step S25, the XML-DOM tree of the partial document having the obtained element as a root element is extracted. Then, at the step S26. this extracted XML-DOM tree is set as the XML-DOM tree of the new XML document.

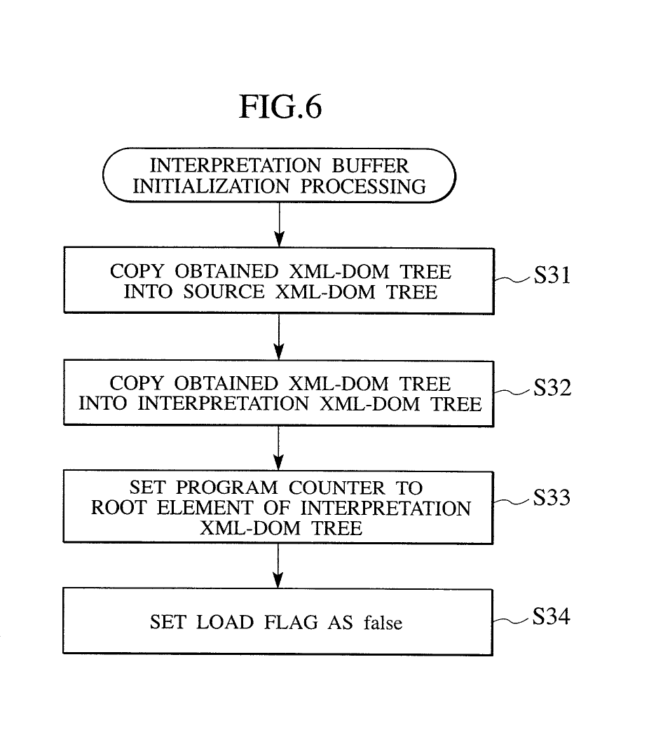

Next, the interpretation buffer initializer 116 generates the interpretation buffer according to the obtained XML-DOM tree. At this point, when the entered web resource is entered from the external of the processing system 100, this interpretation buffer is registered as a default interpretation buffer 103. This initialization processing operation for the interpretation buffer (formed by memories) is shown in FIG. 6. Note that, in the case of the XML-DOM tree of the partial document, the temporal interpretation buffer 104 will be initialized similarly as in FIG. 6.

First, at the step S31, the entered XML-DOM tree is copied into a source XML-DOM tree 134. Note that the source XML-DOM tree 134 is a buffer for storing the initial state of the XML-DOM tree before the change by the subsequent XML-P'z language interpretation processing, which is intended to be used for providing the source of the XML-P'z language but this will not be utilized in this embodiment.

Next, at the step S32, the entered XML-DOM tree is copied into an interpretation XML-DOM tree 131. The interpretation XML-DOM tree 131 is used for reading the structure and writing the interpretation result in the interpretation processing by the interpreter 102.

Next, at the step S33, a program counter 132 is set to a root element of the interpretation XML-DOM tree 131. The program counter 132 is a pointer for storing the progress of the interpretation processing by the interpreter 102.

Finally, at the step S34, a load flag 133 is set as “false”. The load flag 133 is a flag for indicating whether this interpretation buffer 103 is already interpretation processed or not. The interpreter 102 utilizes this load flag 133 in order not to carry out the interpretation processing again for those interpretation buffers to which the interpretation processing was applied in the past.

This completes the description of the processing operation of the interpretation buffer factory 101.

Next, the processing operation of the interpreter 102 will be described.

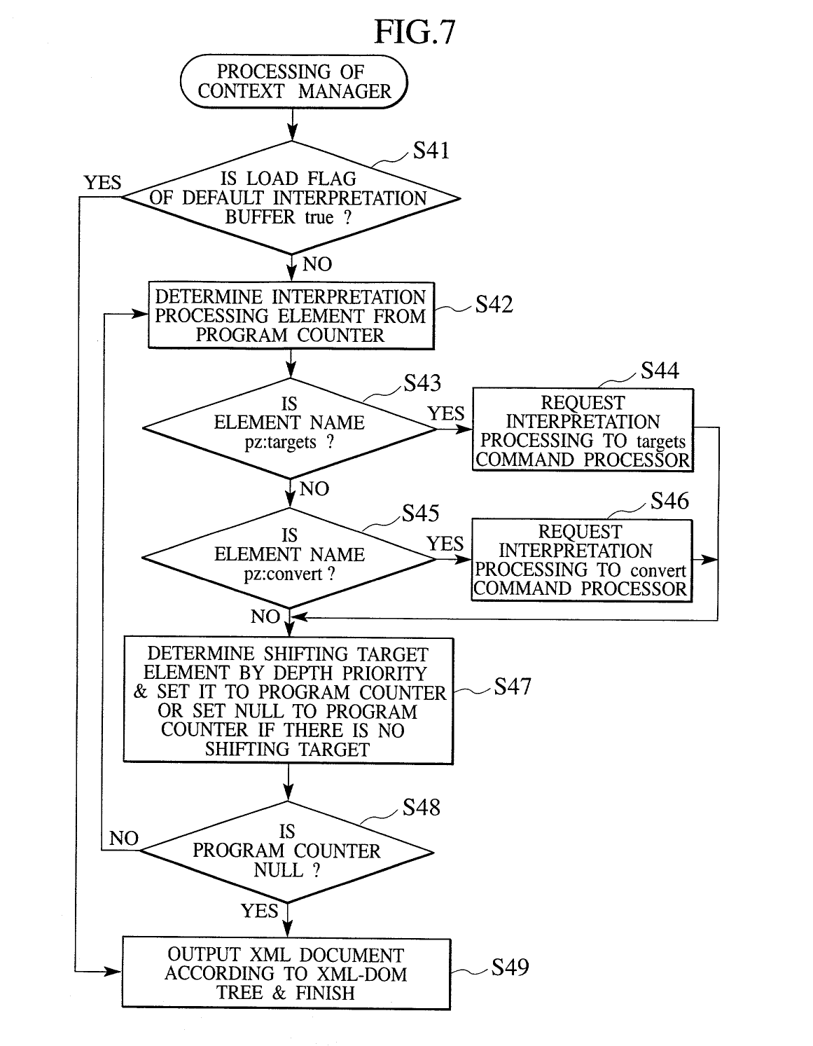

A context manager 121 constituting the interpreter 102 plays a central role in the interpretation processing. The context manager 121 traces through nodes of the interpretation XML-DOM tree 131 or 141 at the depth priority according to the program counter 132 or 142 of the interpretation buffers 103 or 104, and when a command element is discovered, the context manager 121 requests the interpretation processing to a corresponding processing module (the targets command processor 122, the convert command processor 123). When the interpretation processing of the command element is finished, the context manager 121 continues the tracing processing. When the entire processing is finished, the context manager 121 outputs the XML document as the interpretation result. This processing operation is shown in FIG. 7. In the following, the exemplary case of the interpretation processing using the default interpretation buffer 103 will be described, but the processing operation is similar in the case of using the temporal interpretation buffer 104.

First, at the step S41, the load flag 133 of the interpretation buffer 103 is checked. If the load flag 133 is “true” it implies that the interpretation has already been carried out and the processing proceeds to the step S49, whereas if the load flag 133 is “false” it implies that the interpretation processing has not been carried out yet and the processing proceeds to the step S42.

At the step S42, the program counter 132 is read and an element to be the interpretation processing target (which will be referred to as a current element) is determined.

At the step S43, whether the element name of the current element is “pz:targets” or not is checked. If it is “pz:targets”, the processing proceeds to the step S44 where the interpretation processing of the pz:targets element is requested to the targets command processor 122.

Next, at the step S45, whether the element name of the current element is “pz:convert” or not is checked. If it is “pz:convert”, the processing proceeds to the step S46 where the interpretation processing of the pz:convert element is requested to the convert command processor 123.

Next, at the step S47, a shifting target element is determined according to the depth priority and set to the program counter 132. Among the child elements of the current element, if there is an element for which the interpretation processing has not been carried out yet, the eldest brother element among them is set to the program counter 132. If the interpretation processing has already been carried out for all the child elements, the parent element is set to the program counter 132. If there is no parent element, “NULL” is set to the program counter 132.

At the step S48, whether the program counter 132 is “NULL” or not is checked. If it is not “NULL” the processing returns to the step S42, whereas if it is “NULL” the interpretation of the interpretation XML-DOM tree 131 is finished so that the processing proceeds to the step S49.

At the step S49, the XML document is produced and outputted according to the XML-DOM tree 131 of the interpretation buffer 103 by using an XML-DOM parser 151, and the processing is terminated.

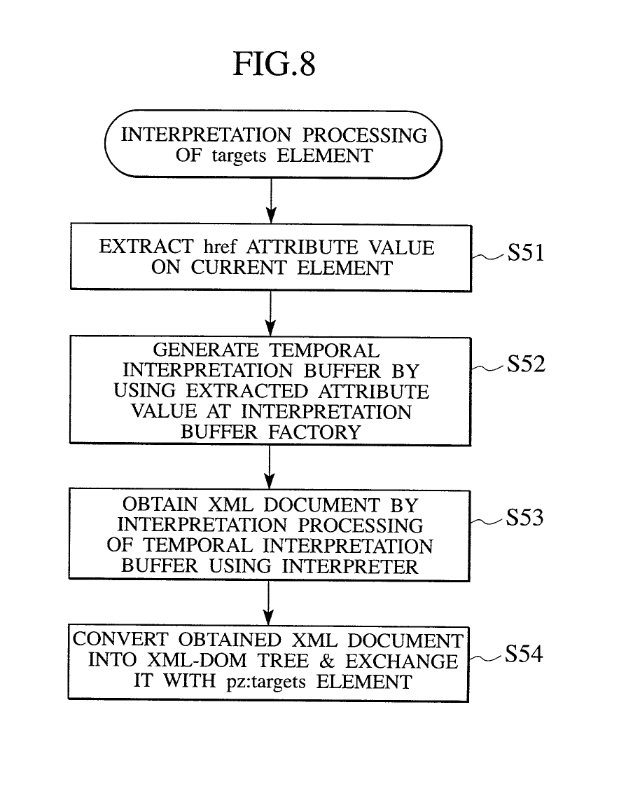

The targets command processor 122 constituting the interpreter 102 interprets the pz:targets element, and writes the interpretation result into the current element. This processing operation is shown in FIG. 8.

First, at the step S51, the href attribute value of the pz:targets element which is the current element is extracted.

Then, at the step S52, the temporal interpretation buffer 104 is generated by using the extracted attribute value as the input URL of the interpretation buffer factory 101, through the processing by the XML normalizer 111 to the interpretation buffer initializer 116 described above. Here, however, when the target URL is the relative URL, the URL is converted into the absolute URL based on the URL of the insertion target interpretation buffer as explained in the relative specification of the URL with XPointer described above.

Next, at the step S53, the interpretation processing of the generated temporal interpretation buffer 104 is carried out by using the interpreter 102 and the XML document is obtained as a result.

Finally, at the step S54, the obtained XML document is converted into the XML-DOM tree by using an XML-DOM parser 152, and the XML-DOM tree is exchanged with the pz:targets element which is the current element. Also, the generated temporal interpretation buffer 104 is discarded.

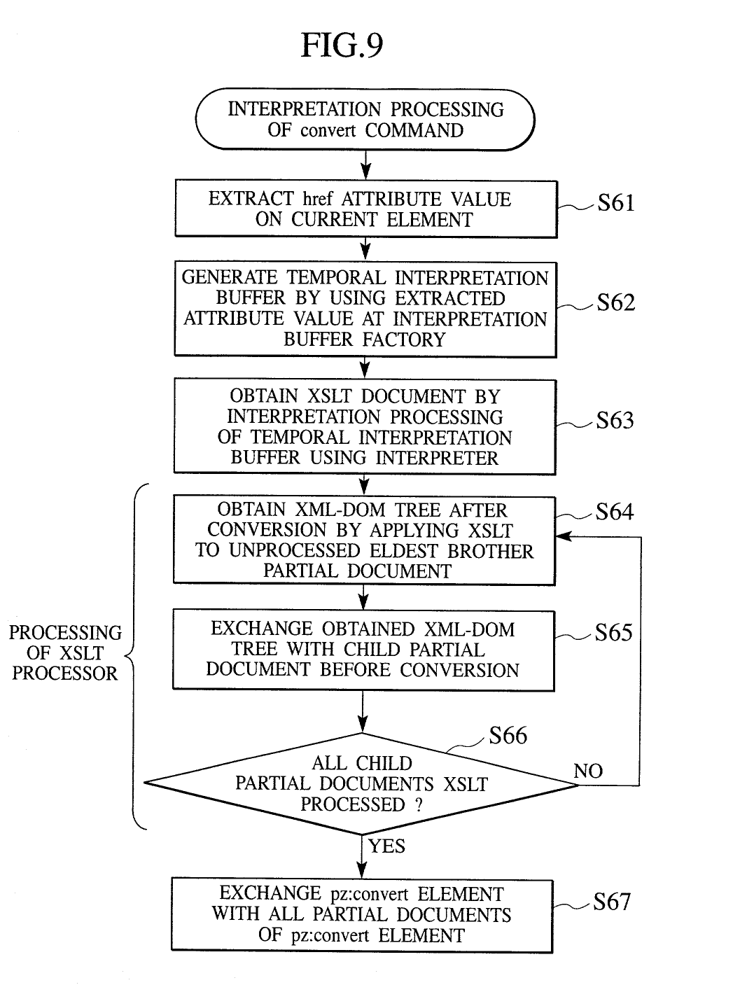

The convert command processor 123 constituting the interpreter 102 interprets the pz:convert element, and writes the interpretation result into the current element. This processing operation is shown in FIG. 9.

First, at the step S61, the href attribute value of the pz:convert element which is the current element is extracted.

Then, at the step S62, the temporal interpretation buffer 104 is generated by using the extracted attribute value as the input URL of the interpretation buffer factory 101, through the processing by the XML normalizer 111 to the interpretation buffer initializer 116 described above. Here, however, when the target URL is the relative URL, the URL is converted into the absolute URL based on the URL of the insertion target interpretation buffer as explained in the relative specification of the URL with XPointer described above.

Next, at the step S63, the interpretation processing of the generated temporal interpretation buffer 104 is carried out by using the interpreter 102 and the XSLT document is obtained as a result. Note that this processing is carried out because the XSLT document itself may possibly be described in the XML-P'z language (that is, the XSLT document may possibly be formed as a result of the composition).

Next, at the step S64, the obtained XSLT document is applied by the XSLT processor 124 to the eldest brother element (and partial documents containing its child and grandchild elements) to which the XSLT has not been applied yet among the child elements of the pz:convert element which is the current element, so as to convert the document structure of the corresponding partial document by using the conversion rule described in the XSLT document.

Then, at the step S65, the obtained XML-DOM tree is exchanged with the child element before the conversion (and the partial documents containing its child and grandchild elements) on the composition web document.

At the step S66, if there is any unprocessed child element, the processing returns to the step S64. If all the child elements are already processed, the processing proceeds to the step S67 where the pz:convert element is exchanged with the all the child partial documents of the pz:convert element obtained by the document structure conversion, by using an XML-DOM parser 153.

This completes the description of the processing operation of the interpreter 102, as well as the description of the constituent elements of the XML-P'z language processing system.

(C) A Series of Operations for Composing a Plurality of Web Documents on a Single Web Document:

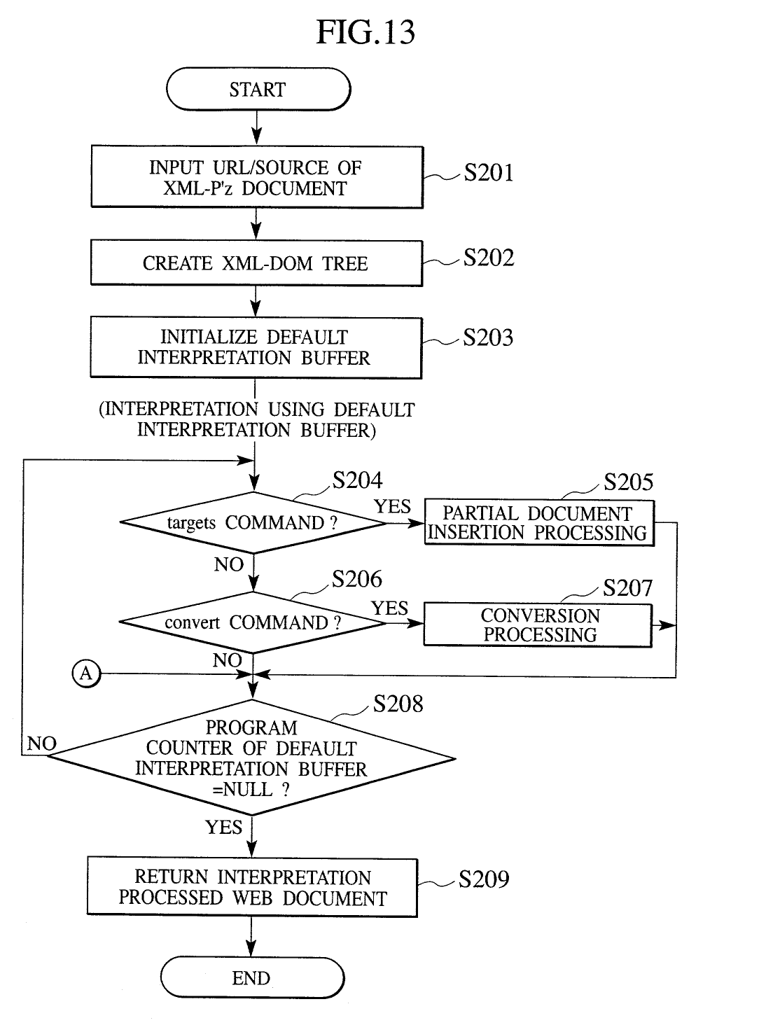

Next, a series of operations for actually extracting a part of the web document W2 of the web server A2, composing each extracted partial document on a single web document, and outputting a composed web document (XML document) W1, by incorporating the XML-P'z language processing system 100 in the configuration shown in FIG. 2 into the web server and carrying out the basic operation shown in FIG. 1, will be described with references to FIG. 13 to FIG. 15.

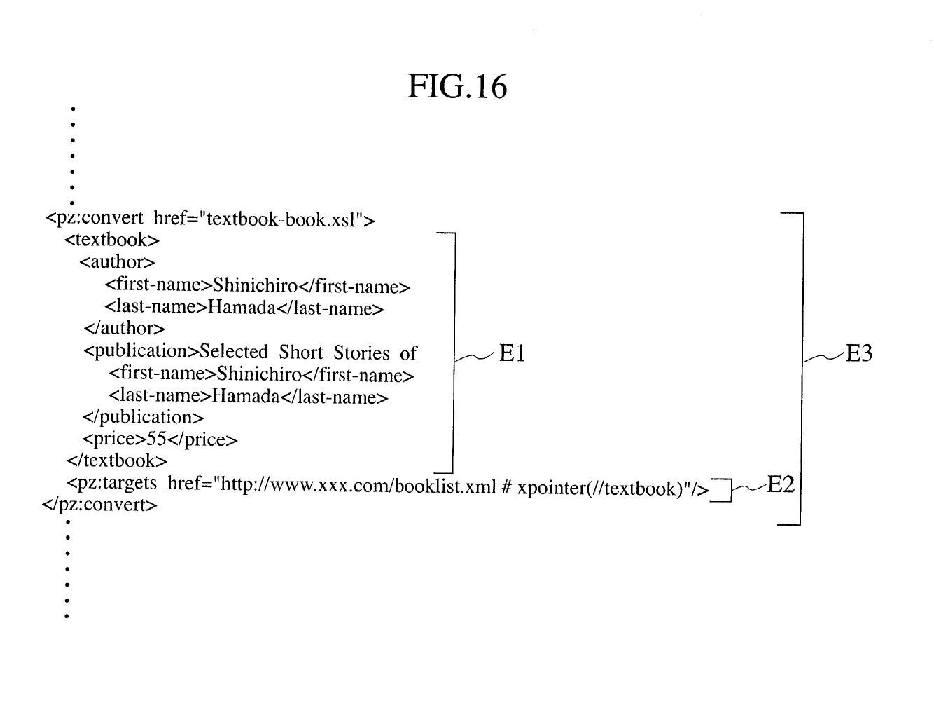

Here, the XML-P'z document 2 to be used as the composition web document is assumed to be as shown in FIG. 16. Note that the XML-P'z document shown in FIG. 16 shows an excerpt from the XML-P'z document 2 of FIG. 1.

The XML-P'z document shown in FIG. 16 is for converting the textbook data contained within the own document expressed by a “textbook” element E1, all the textbook data contained in the web document at “http://www.xxx.com/booklist.xml” to be inserted by the pz:targets element E2 into a common book format according to the conversion rule described in the XSLT document “textbook-book.xsl”, and outputting a composed web document (XML document) W1.

In FIG. 1, suppose that a request for the XML-P'z document 2 is made from the web browser of the client terminal B1 to the XML-P'z server A1 (which will be referred to simply as a server A1 hereafter) (step S201).

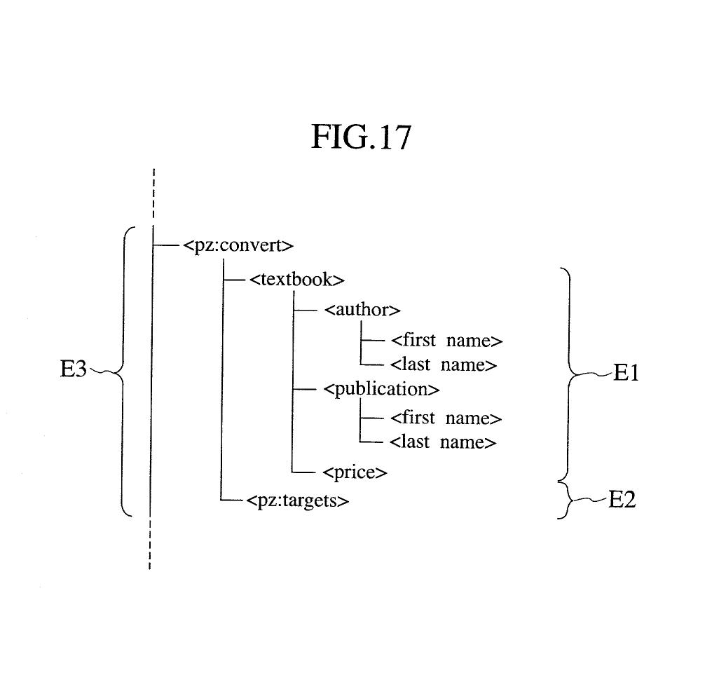

As the requested document is the composition web document (XML-P'z document) 2 possessed by the server A1, the language processing system 100 of the server A1 creates the XML-DOM tree of this XML-P'z document by using the XML-DOM parser 114 (step S202). In this created XML-DOM tree, a portion corresponding to FIG. 16 is as shown in FIG. 17, for example. Note that FIG. 17 only shows an outline for the sake of simplicity.

This created XML-DOM tree is copied to the source and interpretation DOM trees 134 and 131 of the default interpretation buffer 103, and besides that, the default interpretation buffer 103 is initialized by the procedure shown in FIG. 6 (step S203).

Next, the interpretation processing of this default interpretation buffer 103 is carried out at the interpreter 102. Here, it is assumed that the XML-DOM tree as shown in FIG. 17 is to be interpreted, for example.

The interpreter 102 determines the shifting target element according to the depth priority as described above, so that in the XML-DOM tree shown in FIG. 17 the interpretation processing of the pz:targets element E2 is carried out first (steps S204, S205). Then, the interpretation processing of the pz:convert element E3 which is the parent element of the elements El and E2 is carried out (steps S206, S207). Then, though not shown in FIG. 17, the program counter 132 is shifted to a younger brother element or a parent element of the pz:convert element E3, and the interpretation processing of this default interpretation buffer 103 is continued until the program counter becomes “NULL” (step S208).

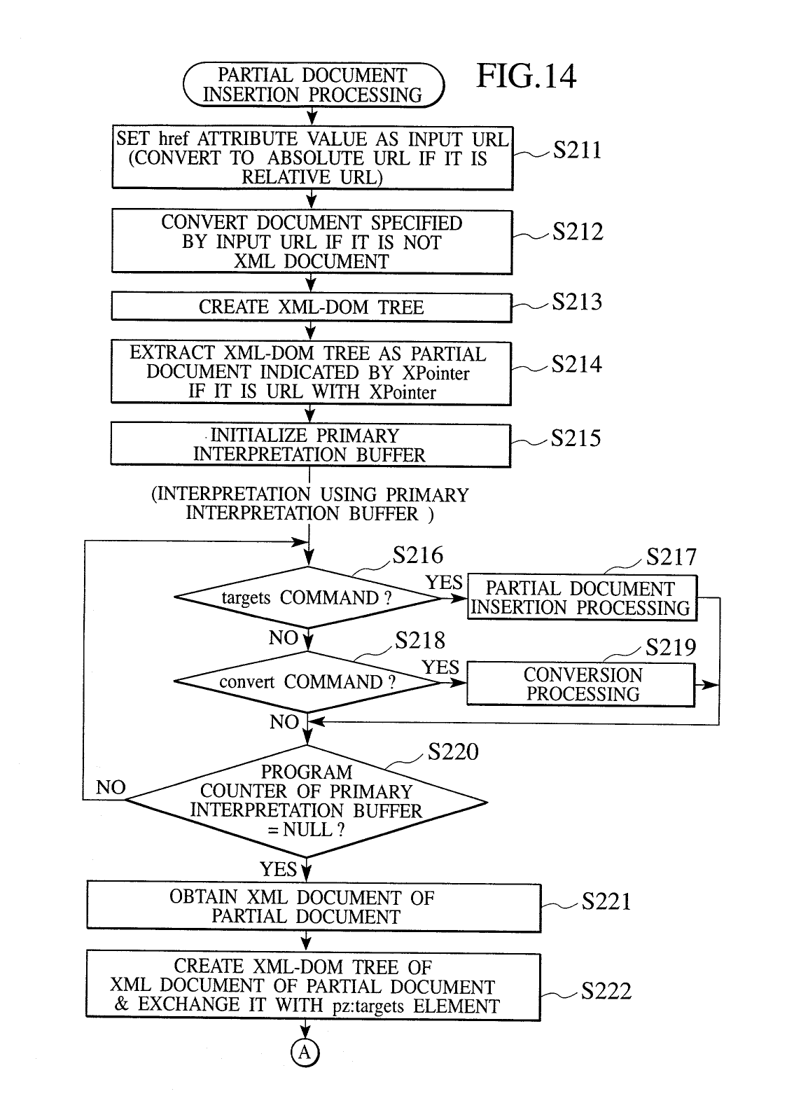

Here, at the step S205, the interpretation processing of the pz:targets element E2 is carried out by the procedure shown in FIG. 14.

The targets command processor 122 extracts the href attribute value of the pz:targets element E2, i.e., “http://www.xxx.com.booklist.xml#xpointer(//textbook)”, and set that attribute value as the input URL of the interpretation buffer factory 101. When the document specified by this input URL is not the XML document, the XML normalizer 111 coverts it into the XML document (step S212) and them the XML-DOM tree of this XML document is created at the XML-DOM parser 114 (step S213). Note that this specified document is the XML document in this example, so that the XML-DOM tree of this XML document is created at the XML-DOM parser 114 directly.

In this case, the input URL is the URL with XPointer indicating the web document W2 of the server A2, so that the XPointer processor 115 takes out the XPointer fragment, i.e., “#xpointer(//textbook)”, and extracts the XML-DOM tree of the “textbook” element (and the partial documents containing its child and grandchild elements) pointed by this XPointer from the XML-DOM tree created at the step S213 (step S214). When a plurality of “textbook” elements exist, this processing is carried out for each one of them. This extracted XML-DOM tree is the XML-DOM tree of the partial document to be inserted.

Next, at the interpretation buffer initializer 116, the temporal interpretation buffer 104 is initialized, and if the pz:targets element or the pz:convert element are described in this partial document, their interpretation processing is carried out and the XML document of this partial document is obtained. If no such elements are described, the interpretation processing of the temporal interpretation buffer 104 is terminated and the context manager 121 generates the XML document from the XML-DOM tree of this partial document by using the XML-DOM parser 151 (steps S215 to S221).

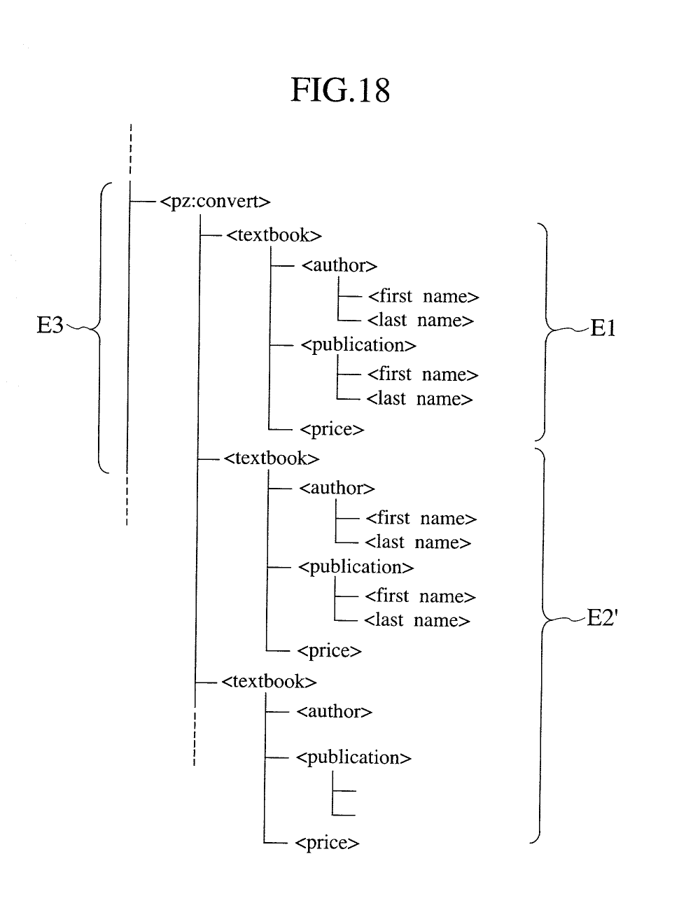

Then, the targets command processor 122 creates the XML-DOM tree of the XML document of this partial document by using the XML-DOM parser 152, and exchanges it with the pz:targets element E2 which is the current element of the interpretation XML-DOM tree 131 of the default interpretation buffer 103, as a partial document group E2′ (step S222). As a result, this partial document group E2′ becomes the child elements of the pz:convert element E3 and the XML-DOM tree is updated, as shown in FIG. 18. The generated temporal interpretation buffer 104 is discarded. Then, the processing returns to the step S208 of FIG. 13.

As shown in FIG. 18, a plurality of textbook data exist in the web document “http://www.xxx.com/booklist.xml”, so that all of them are inserted as the XML-DOM trees of the partial documents of this web document.

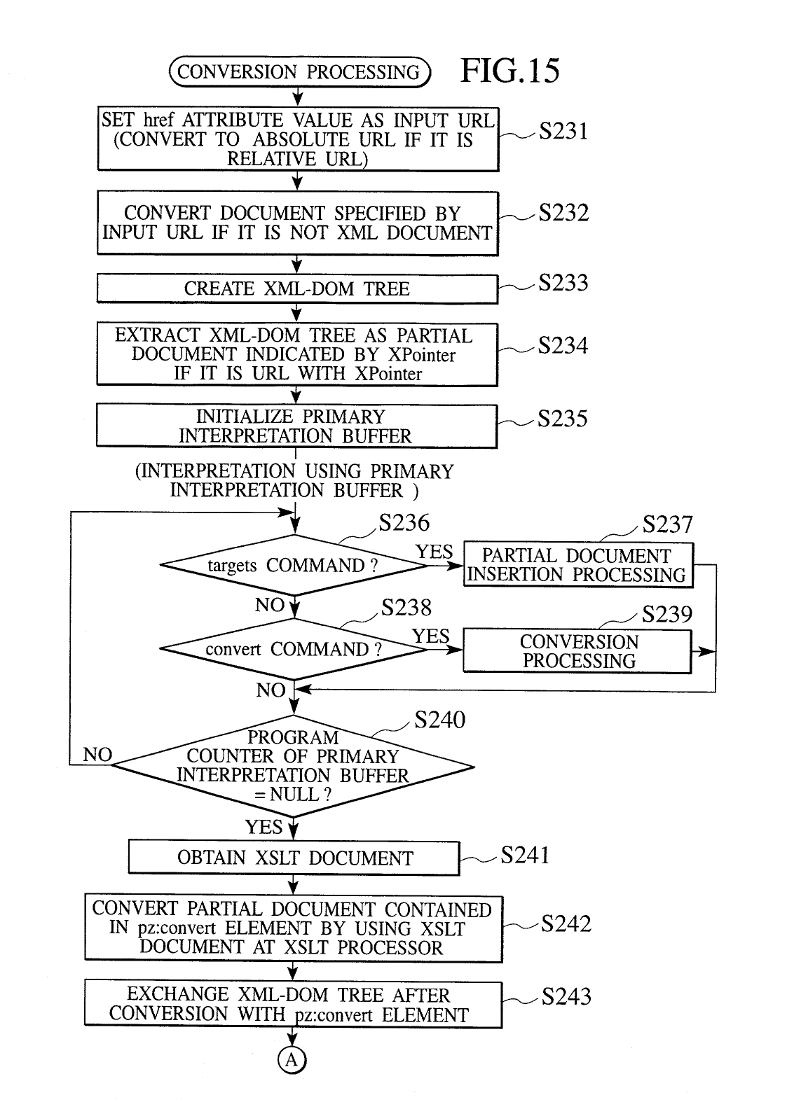

On the other hand, at the step S207, the interpretation processing of the pz:convert element E3 is carried out by the procedure shown in FIG. 15.

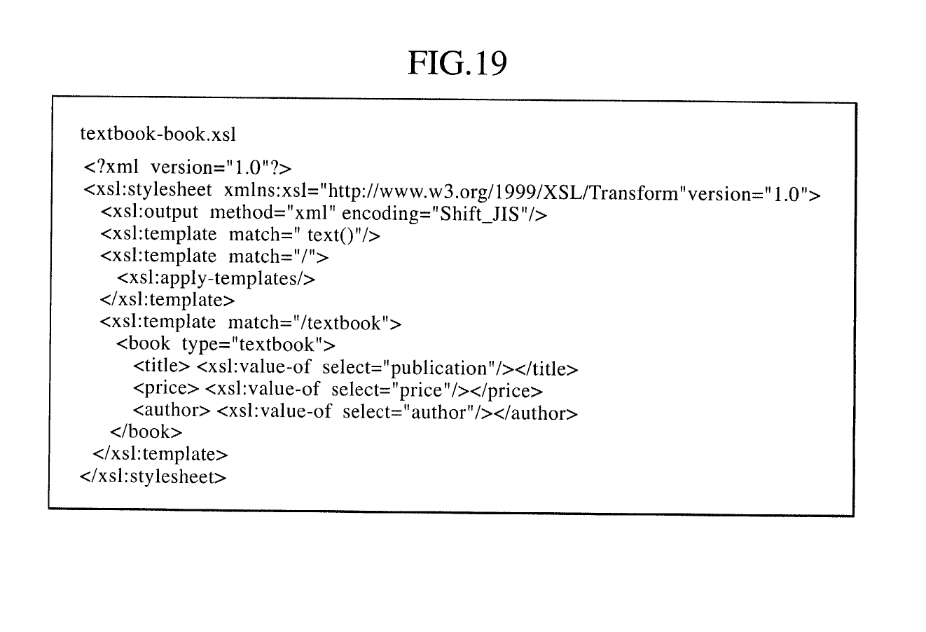

The convert command processor 123 extracts the href attribute value of the pz:convert element E3, i.e., the URL “textbook-book.xsl” of the XSLT document, and set that attribute value as the input URL of the interpretation buffer factory 101. The subsequent steps S232 to S240 are the processing for obtaining the XSLT document as the XML document, where the XSLT document as the XML document as shown in FIG. 19 is obtained at the step S241 of FIG. 15, similarly as the steps S212 to S220 of FIG. 14.

The XSLT document shown in FIG. 19 describes the conversion rule for converting a “publication” element, a “price” element, and an “author” element of the current partial document into a “title” element”, a “price” element, and an “author” element, respectively.

Using the XSLT document as shown in FIG. 19, the XSLT processor 124 converts the partial documents (also referred to as child partial documents) contained in the pz:convert element which is the current element of the interpretation XML-DOM tree 131 of the default interpretation buffer 103 (step S242).

Here, the textbook data contained in the own document and the textbook data extracted from the web document “http://www.xxx.com/booklist.xml” are data in the same structure, so that the conversion of the structure using the XSLT document of FIG. 19 will be described for an exemplary case of the textbook data contained in the own document expressed by the element E1.

As shown in FIG. 16, the value of the “publication” element which is the child element of the element E1 is “Selected Short Stories of Shinichiro Hamada”, and this value becomes the value of the “title” element after the conversion. Also, as shown in FIG. 16, the value of the “author” element which is the child element of the element El is “Shinichiro Hamada”, and this value becomes the value of the “author” element after the conversion. Also, as shown in FIG. 16, the value of the “price” element which is the child element of the element E1 is “55”, and this value remains unchanged after the conversion.

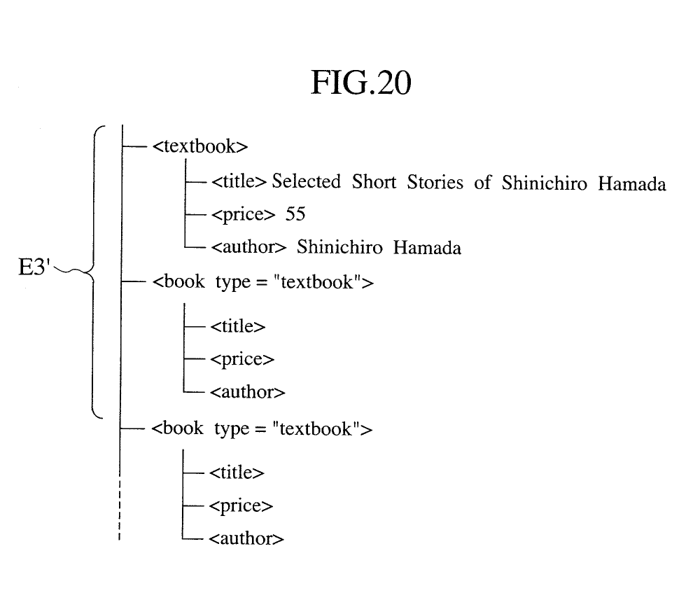

The convert command processor 123 exchanges the XML-DOM tree of the partial document after the conversion with the pz:convert element E3 which is the current element of the interpretation XML-DOM tree 131 of the default interpretation buffer 103, as a new element E3′, so as to generate the XML-DOM tree in the document structure as shown in FIG. 20 (step S243). The generated temporal interpretation buffer 104 is discarded. Then, the processing returns to the step S208 of FIG. 13.

In this way, when the program counter 132 of the default interpretation buffer 103 becomes “NULL” and the interpretation of the XML-DOM tree 131 is finished, the context manager 121 generates and outputs the XML document as the target web document W1 according to the XML-DOM tree 131 of the interpretation buffer 103 containing the XML-DOM tree shown in FIG. 20, by using the XML-DOM parser 151.

Note that when the client terminal B1 is capable of displaying the XML document, the XML document as the web document W1 is directly returned to the web browser of the client terminal B1, but when the client terminal B1 is not capable of displaying the XML document, the stylesheet processing is carried out at the server A1 side to convert the web document W1 into the HTML document, and then the HTML document as the web document W1 is returned to the web browser of the client terminal B1 (step S209 of FIG. 13).

(D) Cooperative Operations Among XML-P'z Servers for the Web Document Composition Processing.

Here, the case where the web document composition processing is to be carried out by cooperative operations among the XML-P'z servers will be described.

For example, in the case where the XML-P'z document of one XML-P'z server is to be inserted during the interpretation processing of the XML-P'z document on another XML-P'z server, there is a problem as to which server should interpret that XML-P'z document to be inserted. namely, when there is a request using the GET command, there is a need to judge whether the XML-P'z document itself should be returned, or the XML document obtained as the interpretation processing result should be returned.

Among the HTTP server (a side to which the XML-P'z document is requested) and the HTTP client (a side which requests the XML-P'z document), if the HTTP client cannot carry out the interpretation processing of the XML-P'z document, there is a limitation that the interpretation processing of the XML-P'z document must be carried out at the HTTP server side.

In order to introduce this limitation into the judgement criteria, it is assumed that the interpretation buffer factory 101 of the XML-P'z language processing system 100 attaches “XML-P'z:enable” to a header of the request using the GET command at a time of requesting the XML-P'z document.

Also, from a viewpoint of the HTTP server, there is an advantage in entrusting the interpretation processing of the XML-P'z document to the HTTP client because the server load can be lowered, but there can be cases where the disclosure of the XML-P'z document is nor desirable for some reason (such as the disclosure of the composition logics contained in the XML-P'z document is undesirable), so that whether the interpretation processing of the XML-P'z language should be carried out at the server side or not depends on the setting.

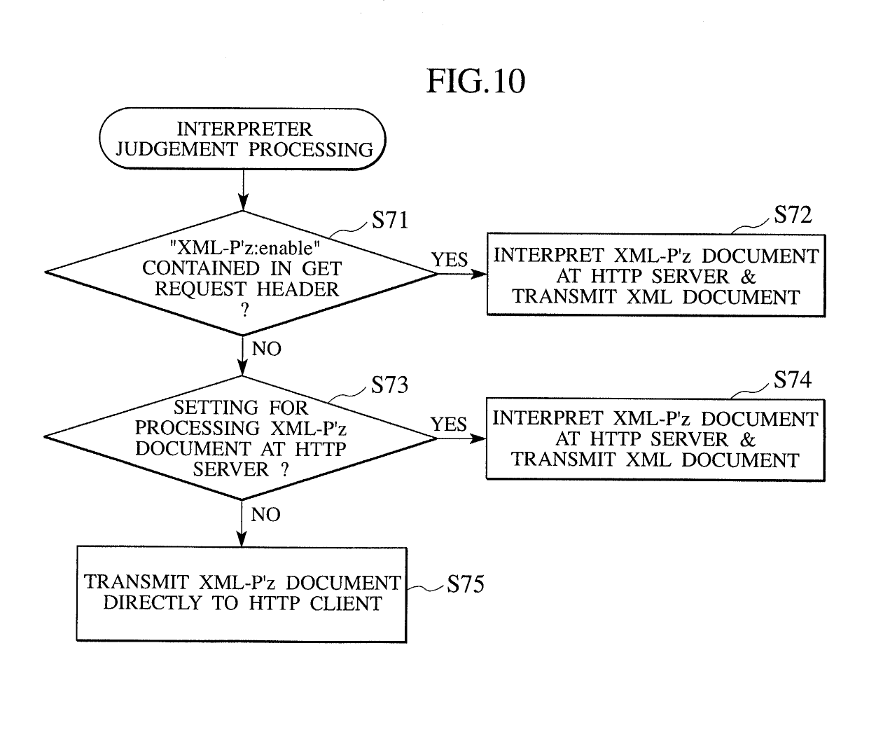

In view of the above, the processing operation for judging whether the interpretation processing is to be carried out by the HTTP server or not will now be described with reference to FIG. 10.

First, at the step S71, whether “XML-P'z:enable” is contained in the GET request header or not is checked. If it is not contained, the processing proceeds to the step S72 where the interpretation processing of the XML-P'z document is carried out at the HTTP server and the processing is terminated. If it is contained, the processing proceeds to the step S73 and whether the setting for processing the XML-P'z document at the HTTP server is set or not is checked. If so, the processing proceeds to the step S74 where the interpretation processing of the XML-P'z document is carried out at the HTTP server and the processing is terminated. If not, the processing proceeds to the step S75 where the XML-P'z document is directly transmitted to the HTTP client without carrying out the interpretation processing.

(E) Notes:

As described above, the present invention defines the XML-P'z (XML-Pieces) document in which a composition web document to be a basis of the composition is described in the XML, portions (partial documents) of specified ranges are extracted from specified other web documents and inserted into specified positions in the composition web document, a conversion processing is applied to a specified range of the composition web document, and two composition logic commands for insertion and conversion are included as elements within the composition web document. The language processing system 100 extracts portions (partial documents) of specified ranges from web documents (pages) W2 and W3 of specified web servers (web servers A2 and A3) and insert them at specified positions in the XML-P'z document, and applies the conversion processing to a specified range described in the XML-P'z document. Eventually, by obtaining the XML document (the composed web document) W1 as a processing result of the XML-P'z language processing system 100, it is possible to carry out the composition of a plurality of web site information on a single web document easily and generically.

It is to be noted that the above described embodiment according to the present invention may be conveniently implemented using a conventional general purpose digital computer programmed according to the teachings of the present specification, as will be apparent to those skilled in the computer art. Appropriate software coding can readily be prepared by skilled programmers based on the teachings of the present disclosure, as will be apparent to those skilled in the software art.

In particular, the XML-P'z language processing system of the above described embodiment can be conveniently implemented in a form of a software package.

Such a software package can be a computer program product which employs a storage medium including stored computer code which is used to program a computer to perform the disclosed function and process of the present invention. The storage medium may include, but is not limited to, any type of conventional floppy disks, optical disks, CD-ROMs, magneto-optical disks, ROMs, RAMs, EPROMs, EEPROMs, magnetic or optical cards, or any other suitable media for storing electronic instructions.

It is also to be noted that, besides those already mentioned above, many modifications and variations of the above embodiment may be made without departing from the novel and advantageous features of the present invention. Accordingly, all such modifications and variations are intended to be included within the scope of the appended claims.

What is claimed is:

1. A document editing method for editing parts of contents of one or a plurality of first documents described by any markup language on a World Wide Web (WWW) in Internet into a second document described by a specific markup language on the WWW, comprising:
extracting one or a plurality partial documents from the first documents according to locations of the first documents on the Internet and ranges of the partial documents to be extracted, described by the specific markup language in the second document; and
inserting the partial documents extracted by the extracting step into the second document according to insertion positions of the partial documents on the second document described by the specific markup language in the second document.

2. The document editing method of claim 1, wherein the extracting step and the inserting step use the second document which is described by using at least a tag for describing the locations of the first documents on the Internet and the ranges of the partial documents to be extracted and specifying the insertion positions of the partial documents on the second document.

3. The document editing method of claim 1, further comprising:
converting a document structure of the second document according to ranges for which the document structure of the second document is to be converted including the partial documents inserted by the inserting step and an identification information of a file describing a conversion rule for converting the document structure into a desired document structure, which are described by the specific markup language in the second document.

4. The document editing method of claim 3, wherein the converting step uses the second document which is described by using at least a tag for specifying the ranges for which the document structure of the second document is to be converted and describing the identification information of the file describing the conversion rule.

5. The document editing method of claim 1, wherein the extracting step uses the second document which is described by Extensible Markup Language (XML), and when the first documents are not described by the XML, the extracting step extracts the partial documents from the first documents after converting the first documents into a description format according to the XML.

6. A document editing apparatus for editing parts of contents of one or a plurality of first documents described by any markup language on a World Wide Web (WWW) in Internet into a second document described by a specific markup language on the WWW, comprising:
an extraction unit configured to extract one or a plurality partial documents from the first documents according to locations of the first documents on the Internet and ranges of the partial documents to be extracted described by the specific markup language in the second document; and
an insertion unit configured to insert the partial documents extracted by the extraction unit into the second document according to insertion positions of the partial documents on the second document described by the specific markup language in the second document.

7. The document editing apparatus of claim 6, wherein the extraction unit and the insertion unit use the second document which is described by using at least a tag for describing the locations of the first documents on the Internet and the ranges of the partial documents to be extracted and specifying the insertion positions of the partial documents on the second document.

8. The document editing apparatus of claim 6, further comprising:
a conversion unit configured to convert a document structure of the second document according to ranges for which the document structure of the second document is to be converted including the partial documents inserted by the insertion unit and an identification information of a file describing a conversion rule for converting the document structure into a desired document structure, which are described by the specific markup language in the second document.

9. The document editing apparatus of claim 8, wherein the conversion unit uses the second document which is described by using at least a tag for specifying the ranges for which the document structure of the second document is to be converted and describing the identification information of the file describing the conversion rule.

10. The document editing apparatus of claim 6, wherein the extraction unit uses the second document which is described by Extensible Markup Language (XML), and when the first documents are not described by the XML, the extracting step extracts the partial documents from the first documents after converting the first documents into a description format according to the XML.

11. A computer program product for causing a computer to function as a document editing apparatus for editing parts of contents of one or a plurality of first documents described by any markup language on a World Wide Web (WWW) in Internet into a second document described by a specific markup language on the WWW, the computer program product comprising:
first computer program codes for causing the computer to configured to extract one or a plurality partial documents from the first documents according to locations of the first documents on the Internet and ranges of the partial documents to be extracted described by the specific markup language in the second document; and
second computer program codes for causing the computer to an insertion unit configured to insert the partial documents extracted by the first computer program codes into the second document according to insertion positions of the partial documents on the second document described by the specific markup language in the second document.

12. The computer program product of claim 11, wherein the first computer program codes and the second computer program codes use the second document which is described by using at least a tag for describing the locations of the first documents on the Internet and the ranges of the partial documents to be extracted and specifying the insertion positions of the partial documents on the second document.

13. The computer program product of claim 11, further comprising:
third second computer program codes for causing the computer to convert a document structure of the second document according to ranges for which the document structure of the second document is to be converted including the partial documents inserted by the second computer program codes and an identification information of a file describing a conversion rule for converting the document structure into a desired document structure, which are described by the specific markup language in the second document.

14. The computer program product of claim 13, wherein the third computer program codes use the second document which is described by using at least a tag for specifying the ranges for which the document structure of the second document is to be converted and describing the identification information of the file describing the conversion rule.

15. The computer program product of claim 11, wherein the first computer program codes use the second document which is described by Extensible Markup Language (XML), and when the first documents are not described by the XML, the first computer program codes extract the partial documents from the first documents after converting the first documents into a description format according to the XML.
